(19) United States
(12) Patent Application Publication
(10) Pub. No.: US 2026/0045206 A1
(43) Pub. Date: Feb. 12, 2026

(54) DISPLAY PANEL AND ELECTRONIC DEVICE INCLUDING THE SAME

(71) Applicant: Samsung Display Co., LTD., Yongin-si (KR)

(72) Inventors: MINJI KIM, Yongin-si (KR); SUNGMIN SON, Yongin-si (KR); WONJUN LEE, Yongin-si (KR); GEUMJU MOON, Yongin-si (KR)

(73) Assignee: Samsung Display Co., LTD., Yongin-si (KR)

(21) Appl. No.: 19/213,461

(22) Filed: May 20, 2025

(30) Foreign Application Priority Data
Aug. 6, 2024 (KR) 10-2024-0104878

(51) Int. Cl. G09G 3/32; G09G 3/3233

(52) U.S. Cl. CPC G09G 3/32; G09G 3/3233; G09G 2300/0819; G09G 2320/0238; G09G 2320/0271

(57) ABSTRACT

A display panel includes a pixel including a pixel circuit and a light-emitting diode, a data line providing a data signal to the pixel, a gate line providing a gate signal to the pixel, and a power line providing a power signal to the pixel. The pixel circuit includes a driving transistor, a switching transistor, a compensation transistor, and a sub-compensation transistor. The sub-compensation transistor is connected between the power line and a second capacitor or connected between the second capacitor and the driving transistor.

### CROSS REFERENCE TO RELATED APPLICATION(S)

This application claims priority to and benefits of Korean Patent Application No. 10-2024-0104878 under 35 U.S.C § 119, filed on Aug. 6, 2024, in the Korean Intellectual Property Office, the entire contents of which are incorporated herein by reference.

### BACKGROUND

### 1. Technical Field

The disclosure relates to a display panel, more specifically to a display panel including a capacitor configured to compensate the voltage at the control electrode of the driving transistor to improve image quality in low grayscale levels.

### 2. Description of the Related Art

Hybrid oxide polysilicon (HOP) pixels refer to pixels that are configured with a combination of low-temperature polycrystalline silicon (LTPS) thin-film transistors and oxide thin-film transistors.

A HOP pixel includes a pixel circuit and a light-emitting diode. The pixel circuit includes a driving transistor, and the driving transistor is configured to control the current flowing through the light-emitting diode. The luminance of the light emitted from the light-emitting diode corresponds to the amount of the current flowing through the light-emitting diode. In case that the voltage at the control electrode of the driving transistor changes, the amount of the current flowing through the light-emitting diode and the luminance of the light emitted from the light-emitting diode may change accordingly.

The pixel circuit of the HOP pixel has an issue in which the current flowing through the light-emitting diode is not sufficiently suppressed during the driving process for displaying low grayscale images. Consequently, there is a problem of blotches appearing in the displayed low grayscale images.

### SUMMARY

An object of the disclosure is to provide a display panel that can prevent blotches in low grayscale images by compensating the voltage at the control electrode of the driving transistor.

According to an embodiment of the disclosure, a display panel may include pixels, data lines, gate lines, and power lines. Each pixel may include a pixel circuit and a light-emitting diode. The data lines may provide data signals to the pixels. The gate lines may provide gate signals to the pixels. The power lines may provide power signals to the pixels. The pixel circuit may include a driving transistor, a switching transistor, a compensation transistor, a first capacitor, a second capacitor, and a sub-compensation transistor. The driving transistor may be electrically connected to the light-emitting diode. The driving transistor may include an input electrode, an output electrode, and a control electrode. The switching transistor may be controlled by a gate signal. The switching transistor may be connected between the data line and the driving transistor. The compensation transistor may be connected between the output electrode of the driving transistor and the control electrode of the driving transistor. The first capacitor may be connected between the power line and the compensation transistor. The second capacitor may be connected between the power line and the driving transistor. The sub-compensation transistor may be connected between the power line and the second capacitor or between the driving transistor and the second capacitor.

In an embodiment of the disclosure, the sub-compensation transistor may turn on in case that the data signal corresponds to a low grayscale. The sub-compensation transistor may turn off in case that the data signal corresponds to a high grayscale.

The display panel according to an embodiment of the disclosure may further include a first initialization line and a first initialization transistor. The first initialization line may provide a first initialization signal to the pixel. The first initialization transistor may turn on simultaneously with the compensation transistor during a selected period to transmit the first initialization signal.

In an embodiment of the disclosure, the first initialization transistor may be connected between the first initialization line and the input electrode of the compensation transistor. In another embodiment, the first initialization transistor may be connected between the first initialization line and the output electrode of the driving transistor.

The display panel according to an embodiment of the disclosure may further include a bias signal line and a bias transistor. The bias signal line may provide a bias signal to the pixel. The bias transistor may be connected between the bias signal line and the driving transistor. In an embodiment of the disclosure, the bias transistor may be controlled by a first signal, and the first initialization transistor may be controlled by a second signal. The first signal and the second signal may have a same waveform and different phases.

The display panel according to an embodiment of the disclosure may further include a second initialization line and a second initialization transistor. The second initialization line may provide a second initialization signal to the pixel. The second initialization transistor may be connected between the second initialization line and the light-emitting diode. The second initialization transistor may be controlled by a same signal as the bias transistor.

The display panel according to an embodiment of the disclosure may further include an emission control line, a first emission transistor, and a second emission transistor. The emission control line may provide an emission control signal to the pixel. The first emission transistor may be controlled by the emission control signal. The first emission transistor may be connected between the power line and the driving transistor. The second emission transistor may be controlled by the emission control signal. The second emission transistor may be connected between the driving transistor and the light-emitting diode.

According to another embodiment of the disclosure, a display panel may include pixels, data lines, gate lines, power lines, and a first initialization line. Each pixel may include a pixel circuit and a light-emitting diode. The data lines may provide data signals to the pixels. The gate lines may provide gate signals to the pixels. The power lines may provide power signals to the pixels. The first initialization line may provide a first initialization signal to the pixels. The pixel circuit may include a driving transistor, a switching transistor, a compensation transistor, a first capacitor, a second capacitor, and a first initialization transistor. The driving transistor may be electrically connected to the light-emitting diode. The driving transistor may include an input electrode, an output electrode, and a control electrode. The switching transistor may be controlled by a gate signal. The switching transistor may be connected between the data line and the driving transistor. The compensation transistor may be connected between the output electrode and the control electrode of the driving transistor. The first capacitor may be connected between the power line and the compensation transistor. The second capacitor may be connected between the power line and the driving transistor. The first initialization transistor may be connected between the first initialization line and the output electrode of the driving transistor. The first initialization transistor may turn on simultaneously with the compensation transistor during a selected period.

The display panel according to an embodiment of the disclosure may further include a bias signal line and a bias transistor. The bias signal line may provide a bias signal to the pixels. The bias transistor may be connected between the bias signal line and the driving transistor.

In an embodiment of the disclosure, the bias transistor may be controlled by a first signal, and the first initialization transistor may be controlled by a second signal. The first signal and the second signal may have a same waveform and different phases.

The display panel according to an embodiment of the disclosure may further include a second initialization line and a second initialization transistor. The second initialization line may provide a second initialization signal to the pixels. The second initialization transistor may be connected between the second initialization line and the light-emitting diode. The second initialization transistor may be controlled by a same signal as the bias transistor.

The display panel according to an embodiment of the disclosure may further include a sub-compensation transistor. The sub-compensation transistor may be connected between the power line and the second capacitor or between the driving transistor and the second capacitor.

In an embodiment of the disclosure, the sub-compensation transistor may be turned on in case that the data signal corresponds to a low grayscale. The sub-compensation transistor may turn off in case that the data signal corresponds to a high grayscale.

The display panel according to an embodiment of the disclosure may further include an emission control line, a first emission transistor, and a second emission transistor. The emission control line may provide an emission control signal to the pixel. The first emission transistor may be controlled by the emission control signal. The first emission transistor may be connected between the power line and the driving transistor. The second emission transistor may be controlled by the emission control signal. The second emission transistor may be connected between the driving transistor and the light-emitting diode.

In an embodiment of the disclosure, the driving transistor may further include a sub-control electrode. The sub-control electrode may be electrically connected to the power line.

The display panel according to an embodiment of the disclosure may include a metal pattern, a first semiconductor pattern, a first conductive pattern, a second conductive pattern, a second semiconductor pattern, a third conductive pattern, a lower-connection electrode pattern, an upper-connection electrode pattern, and an anode pattern. The first semiconductor pattern may be disposed on the metal pattern. The first semiconductor pattern may include first to sixth lower-semiconductor portions. The first lower-semiconductor portion may overlap the metal pattern. The second and third lower-semiconductor portions may each extend from one end of the first lower-semiconductor portion. The fourth lower-semiconductor portion may extend from the third lower-semiconductor portion. The fifth lower-semiconductor portion may extend from the other end of the first lower-semiconductor portion. The sixth lower-semiconductor portion may extend from the fifth lower-semiconductor portion. The first conductive pattern may be disposed on the first semiconductor pattern and may include first to fifth lower-electrode portions, which may overlap, respectively, the first to fifth lower-semiconductor portions, which may be spaced apart from each other. The second conductive pattern may be disposed on the first conductive pattern. The second conductive pattern may include first to fifth upper-sub-electrode portions. The second and third upper-sub-electrode portions may each extend from the first upper-sub-electrode portion. The first to third upper-sub-electrode portions may each overlap the first lower-electrode portion. The fourth and fifth upper-sub-electrode portions may be spaced apart from the first to third upper-sub-electrode portions. The second semiconductor pattern may be disposed on the second conductive pattern and may include first and second upper-semiconductor portions. The first upper-semiconductor portion may overlap the fourth upper-sub-electrode portion. The second upper-semiconductor portion may overlap the fifth upper-sub-electrode portion. The third conductive pattern may be disposed on the second semiconductor pattern. The first upper-electrode portion may overlap the first upper-semiconductor portion. The second upper-electrode portion may overlap the second upper-semiconductor portion.

The display panel according to an embodiment of the disclosure may further include a lower-connection electrode pattern, which may be disposed on the third conductive pattern. The lower-connection electrode pattern may include first to fifth lower-connection electrodes. The first lower-connection electrode may contact the first lower-semiconductor portion, the second lower-semiconductor portion, the second upper-sub-electrode portion and the third upper-sub-electrode portion. The second lower-connection electrode may contact the fourth lower-semiconductor portion and the fifth lower-semiconductor portion. The third lower-connection electrode may contact the first upper-semiconductor portion and the second upper-semiconductor portion. The fourth lower-connection electrode may contact the first upper-semiconductor portion and the first lower-semiconductor portion. The fifth lower-connection electrode may contact the fifth lower-semiconductor portion.

The display panel according to an embodiment of the disclosure may further include an upper-connection electrode pattern and an anode pattern. The upper-connection electrode pattern may be disposed on the lower-connection electrode pattern. The upper-connection electrode pattern may include a first upper-connection electrode. The upper-connection electrode pattern may contact the third and fifth lower-semiconductor portions. The anode pattern may be disposed on the upper-connection electrode pattern. The anode pattern may contact the first upper-connection electrode.

An electronic device according to an embodiment of the disclosure may include a display panel. The display panel may include pixels, data lines, gate lines, and power lines. Each pixel may include a pixel circuit and a light-emitting diode. The data lines may provide data signals to the pixels. The gate lines may provide gate signals to the pixels. The power lines may provide power signals to the pixels. The pixel circuit may include a driving transistor, a switching transistor, a compensation transistor, a first capacitor, a second capacitor, and a sub-compensation transistor. The driving transistor may be electrically connected to the light-emitting diode. The driving transistor may include an input electrode, an output electrode, and a control electrode. The switching transistor may be controlled by a gate signal. The switching transistor may be connected between the data line and the driving transistor. The compensation transistor may be connected between the output electrode of the driving transistor and the control electrode of the driving transistor. The first capacitor may be connected between the power line and the compensation transistor. The second capacitor may be connected between the power line and the driving transistor. The sub-compensation transistor may be connected between the power line and the second capacitor or between the driving transistor and the second capacitor.

With the display panel according to an embodiment of the disclosure, it is possible to prevent blotches in low grayscale images by compensating the voltage at the control electrode of the driving transistor.

### BRIEF DESCRIPTION OF THE DRAWINGS

These and/or other features will become apparent and more readily appreciated from the following description of the embodiments, taken in conjunction with the accompanying drawings in which:

FIG. 1A is a schematic perspective view of a device according to an embodiment;

FIG. 1B is a schematic view showing the device of FIG. 1A operating in an always-on display (AOD) mode;

FIG. 2A is a schematic plan view of a display panel according to an embodiment;

FIG. 2B is a schematic block diagram of a display panel according to an embodiment;

FIG. 3A is a schematic diagram of an equivalent circuit of a pixel according to an embodiment;

FIG. 3B is a schematic waveform diagram showing signals input to the pixel of FIG. 3A;

FIG. 3C is a schematic waveform diagram illustrating signals output from the pixel in response to the signals of FIG. 3B, divided according to the capacitance of the second capacitor;

FIGS. 4A to 4F are schematic diagrams of equivalent circuits of pixels further including a sub-compensation transistor;

FIGS. 4G and 4H are schematic waveform diagrams showing input and output signals of the pixel in FIG. 4A;

FIGS. 5A and 5B are schematic diagrams of equivalent circuits of pixels in which the driving transistor and the first initialization transistor are connected in a manner different from FIG. 3;

FIG. 6 is a schematic plan view showing the layout of the pixel circuit according to an embodiment;

FIG. 7 is a schematic plan view of a metal pattern;

FIG. 8A is a schematic plan view of a first semiconductor pattern;

FIG. 8B is a schematic view showing the overlapping layout of FIG. 7 and FIG. 8A;

FIG. 9A is a schematic plan view of a first conductive pattern;

FIG. 9B is a schematic view showing the overlapping layout of FIG. 8B and FIG. 9A;

FIG. 10A is a schematic plan view of a second conductive pattern;

FIG. 10B is a schematic view showing the overlapping layout of FIG. 9B and FIG. 10A;

FIG. 11A is a schematic plan view of a first contact pattern;

FIG. 11B is a schematic view showing the overlapping layout of FIG. 10B and FIG. 11A;

FIG. 12A is a schematic plan view of a second semiconductor pattern;

FIG. 12B is a schematic view showing the overlapping layout of FIG. 11B and FIG. 12A;

FIG. 13A is a schematic plan view of a third conductive pattern;

FIG. 13B is a schematic view showing the overlapping layout of FIG. 12B and FIG. 13A;

FIG. 14A is a schematic plan view of a second contact pattern;

FIG. 14B is a schematic view showing the overlapping layout of FIG. 13B and FIG. 14A;

FIG. 15A is a schematic plan view of a third contact pattern;

FIG. 15B is a schematic view showing the overlapping layout of FIG. 14B and FIG. 15A;

FIG. 16A is a schematic plan view of a first connection electrode pattern;

FIG. 16B is a schematic view showing the overlapping layout of FIG. 15B and FIG. 16A;

FIG. 17A is a schematic plan view of a second connection electrode pattern;

FIG. 17B is a schematic view showing the overlapping layout of FIG. 16B and FIG. 17A;

FIG. 18A is a schematic plan view of an anode pattern; and

FIG. 18B is a schematic view showing the overlapping layout of FIG. 17B and FIG. 18A.

### DETAILED DESCRIPTION OF THE EMBODIMENTS

In the following description, for the purposes of explanation, numerous specific details are set forth in order to provide a thorough understanding of various embodiments or implementations of the disclosure. As used herein “embodiments” and “implementations” are interchangeable words that are non-limiting examples of devices or methods disclosed herein. It is apparent, however, that various embodiments may be practiced without these specific details or with one or more equivalent arrangements. Here, various embodiments do not have to be exclusive nor limit the disclosure. For example, specific shapes, configurations, and characteristics of an embodiment may be used or implemented in an embodiment.

Unless otherwise specified, the illustrated embodiments are to be understood as providing features of the disclosure. Therefore, unless otherwise specified, the features, components, modules, layers, films, panels, regions, and/or aspects, etc. (hereinafter individually or collectively referred to as “elements”), of the various embodiments may be otherwise combined, separated, interchanged, and/or rearranged without departing from the disclosure.

The use of cross-hatching and/or shading in the accompanying drawings is generally provided to clarify boundaries between adjacent elements. As such, neither the presence nor the absence of cross-hatching or shading conveys or indicates any preference or requirement for particular materials, material properties, dimensions, proportions, commonalities between illustrated elements, and/or any other characteristic, attribute, property, etc., of the elements, unless specified. Further, in the accompanying drawings, the size and relative sizes of elements may be exaggerated for clarity and/or descriptive purposes. When an embodiment may be implemented differently, a specific process order may be performed differently from the described order. For example, two consecutively described processes may be performed substantially at the same time or performed in an order opposite to the described order. Also, like reference numerals and/or reference characters denote like elements.

When an element, such as a layer, is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. To this end, the term “connected” may refer to physical, electrical, and/or fluid connection, with or without intervening elements. Further, the X-axis, the Y-axis, and the Z-axis are not limited to three axes of a rectangular coordinate system, such as the x, y, and z axes, and may be interpreted in a broader sense. For example, the X-axis, the Y-axis, and the Z-axis may be perpendicular to one another, or may represent different directions that are not perpendicular to one another. For the purposes of this disclosure, “at least one of A and B” may be construed as A only, B only, or any combination of A and B. Also, “at least one of X, Y, and Z” and “at least one selected from the group consisting of X, Y, and Z” may be construed as X only, Y only, Z only, or any combination of two or more of X, Y, and Z. As used herein, the term “and/or” includes any and all combinations of one or more of the associated listed items.

Throughout the specification, when an element is referred to as being “connected” to another element, the element may be “directly connected” to another element, or “electrically connected” to another element with one or more intervening elements interposed therebetween. Also, when an element is referred to as being “in contact” or “contacted” or the like to another element, the element may be in “electrical contact” or in “physical contact” with another element; or in “indirect contact” or in “direct contact” with another element.

Although the terms “first,” “second,” etc. may be used herein to describe various types of elements, these elements should not be limited by these terms. These terms are used to distinguish one element from another element. Thus, a first element discussed below could be termed a second element without departing from the teachings of the disclosure.

Throughout the specification, when an element is referred to as being “connected” to another element, the element may be “directly connected” to another element, or “electrically connected” to another element with one or more intervening elements interposed therebetween. Also, when an element is referred to as being “in contact” or “contacted” or the like to another element, the element may be in “electrical contact” or in “physical contact” with another element; or in “indirect contact” or in “direct contact” with another element.

Although the terms “first,” “second,” etc. may be used herein to describe various types of elements, these elements should not be limited by these terms. These terms are used to distinguish one element from another element. Thus, a first element discussed below could be termed a second element without departing from the teachings of the disclosure.

Spatially relative terms, such as “beneath,” “below,” “under,” “lower,” “above,” “upper,” “over,” “higher,” “side” (e.g., as in “sidewall”), and the like, may be used herein for descriptive purposes, and, thereby, to describe one elements relationship to another element(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the term “below” can encompass both an orientation of above and below. Furthermore, the apparatus may be otherwise oriented (e.g., rotated 90 degrees or at other orientations), and, as such, the spatially relative descriptors used herein interpreted accordingly.

It will be understood that when an element such as a layer, film, region, or substrate is referred to as being “on” or “over” another element, it can be directly on the other element or intervening element(s) may also be present. In contrast, when an element is referred.

The term overlap may include layer, stack, face or facing, extending over, covering or partly covering or any other suitable term as would be appreciated and understood by those of ordinary skill in the art.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof. It is also noted that, as used herein, the terms “substantially,” “about,” and other similar terms, are used as terms of approximation and not as terms of degree, and, as such, are utilized to account for inherent deviations in measured, calculated, and/or provided values that would be recognized by one of ordinary skill in the art.

Various embodiments are described herein with reference to sectional and/or exploded illustrations that are schematic illustrations of embodiments and/or intermediate structures. As such, variations from the shapes of the illustrations as a result, for example, of manufacturing techniques and/or tolerances, are to be expected. Thus, embodiments disclosed herein should not necessarily be construed as limited to the particular illustrated shapes of regions, but are to include deviations in shapes that result from, for instance, manufacturing. In this manner, regions illustrated in the drawings may be schematic in nature and the shapes of these regions may not reflect actual shapes of regions of a device and, as such, are not necessarily intended to be limiting.

Like or identical reference numerals refer to like or identical elements. Moreover, in the accompanying drawings, the thicknesses, ratios, and dimensions of the elements may not be to exact scale and may have been exaggerated for the benefit of effective explanation of the technical features associated with these elements. As such, the disclosure shall not be restricted to the thicknesses, ratios, dimensions, etc. illustrated in the drawings. The term “and/or” shall include the combination of listed items or any of listed items that can be defined by relevant elements.

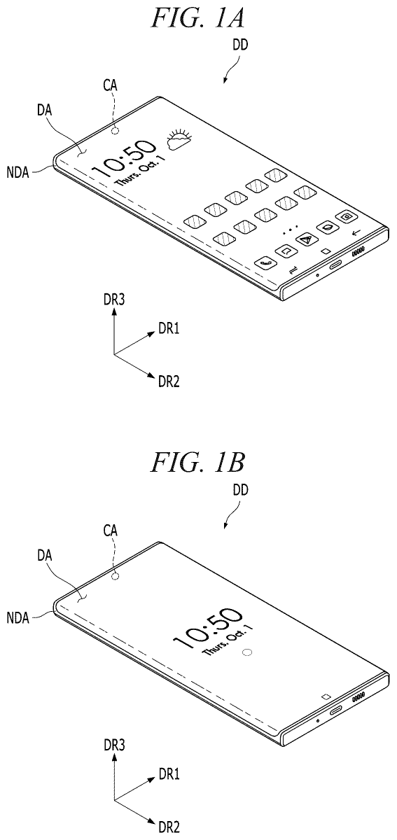

FIG. 1A is a schematic perspective view of an electronic device DD according to an embodiment. FIG. 1B is a schematic view showing the electronic device of FIG. 1A operating in an always-on display (AOD) mode.

Referring to FIGS. 1A and 1B, the electronic device DD can operate in an AOD mode to provide a low grayscale image corresponding to information, such as time and date, for the convenience of a user. Therefore, the user can receive information for convenience (e.g., time and date) without operating the electronic device DD. The electronic device DD may include an oxide thin-film transistor capable of low-frequency driving for displaying low grayscale images.

The electronic device DD may have a display area DA and a non-display area NDA defined therein. An image may be displayed in the display area DA. The display area DA may be parallel to a plane defined by a first direction DR1 and a second direction DR2. A third direction DR3 may be the normal direction of the display area DA. The thickness direction of the electronic device DD may correspond to the third direction DR3. The front (or upper) surface and the rear (or lower) surface of each member may be distinguished by the third direction DR3. The first to third directions are relative concepts and thus can be converted to other directions. In this specification, the first to third directions may be respectively the first to third directions DR1-DR3 in FIGS. 1A and 1B. The shape of the display area DA shown in FIGS. 1A and 1B is one of the embodiments, and the shape of the display area DA may be modified without limitation as needed.

The non-display area NDA may be a region where images are not displayed. The non-display area NDA may be adjacent to the display area DA. A bezel area of the electronic device DD may be defined by the non-display area NDA. The non-display area NDA may surround the display area DA. The shape of the non-display area NDA in the disclosure is not limited to what is described herein, and the shape of the non-display area NDA may be modified without limitation as needed.

A camera area CA may overlap the display area DA. Depending on whether or not a camera function is in use, images may or may not be displayed in the camera area CA. For example, if the user is not using the camera function, images may be displayed in the camera area CA. On the other hand, if the user is using the camera function, images may not be displayed in the camera area CA.

In FIGS. 1A and 1B, the electronic device DD is illustrated as a smartphone, but the electronic device DD of the disclosure is not limited to what is illustrated herein. In other embodiments, the electronic device DD may be any of a large electronic device or a medium-to small-sized electronic device. For example, large electronic devices may include televisions, monitors, and electronic billboards. Moreover, medium-to small-sized electronic devices may include tablets, built-in display appliances, smartwatches, and smartphones.

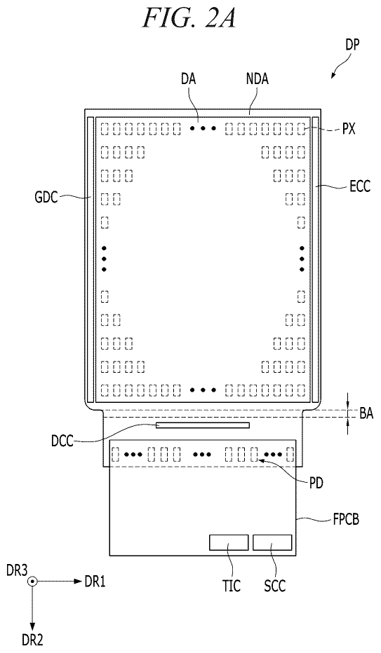

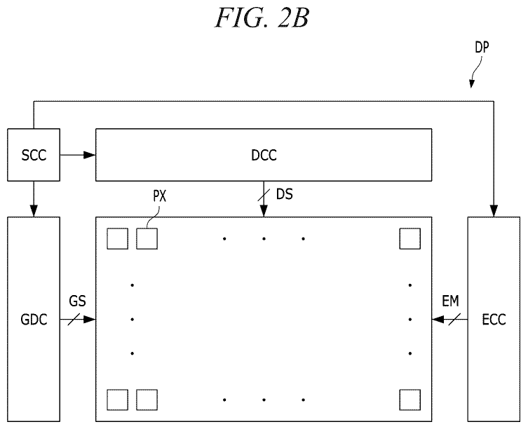

FIG. 2A illustrates a schematic plan view of a display panel DP according to an embodiment. FIG. 2B is a schematic block diagram of the display panel DP according to an embodiment. The display panel DP may be mounted in the electronic device DD shown in FIGS. 1A and 1B. Referring to FIGS. 2A and 2B, the display panel DP may include pixels PX, a gate driver circuit GDC, an emission control circuit ECC, a data driver circuit DCC, a flexible printed circuit board FPCB, an input detection driving circuit TIC, a signal control circuit SCC, and pads PD.

The display panel DP may have a display area DA and a non-display area NDA defined therein. The display area DA and the non-display area NDA of the display panel DP may respectively correspond to the display area DA and the non-display area NDA of the electronic device DD illustrated in FIGS. 1A and 1B.

The gate driver circuit GDC may receive a control signal from the signal control circuit SCC and provide a gate control signal GS to the pixels PX via gate lines. In an embodiment, the gate driver circuit GDC may be formed simultaneously with the pixels PX through a thin-film process. For example, the gate driver circuit GDC may be installed in the form of an oxide semiconductor TFT gate driver circuit (OSG) or an amorphous silicon TFT gate driver circuit (ASG).

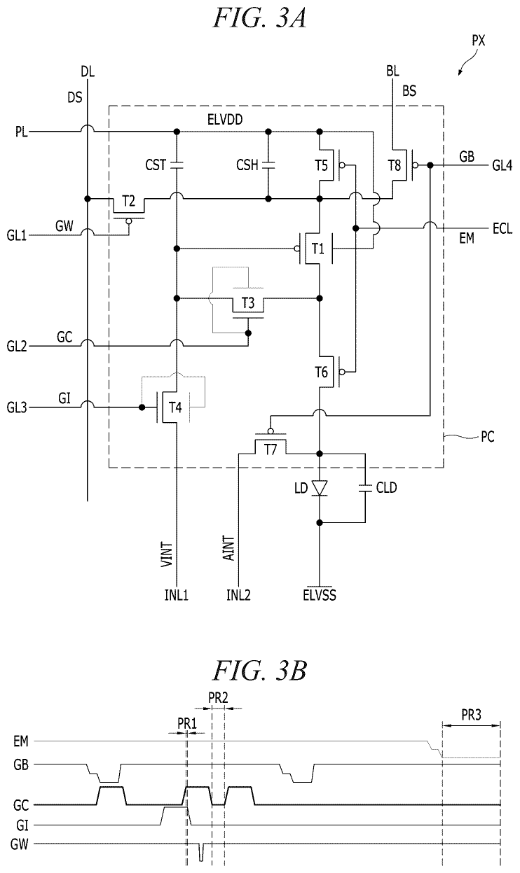

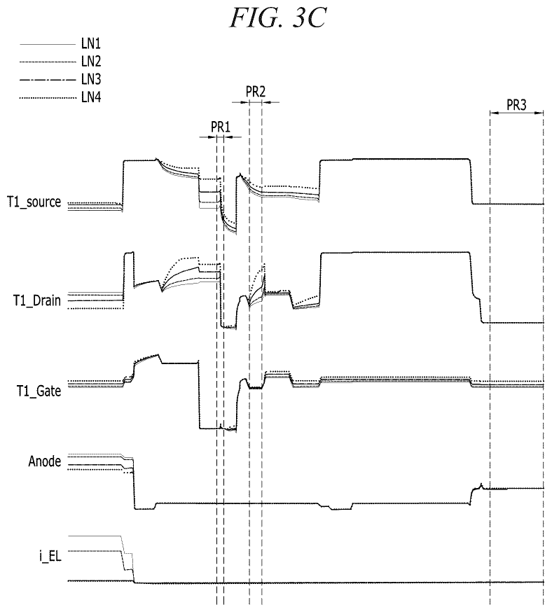

The emission control circuit ECC may receive a control signal from the signal control circuit SCC and provide an emission control signal EM to the pixels PX. The data driver circuit DCC may receive a control signal from the signal control circuit SCC and provide a data signal DS to the pixels PX via data lines (e.g., DL in FIG. 3A).

The input detection driving circuit TIC and the signal control circuit SCC may be mounted on the flexible printed circuit board FPCB and may receive electrical signals from the pads PD. The input detection driving circuit TIC may process signals corresponding to user touch inputs and signals corresponding to externally applied pressure.

The signal control circuit SCC (e.g., a timing controller) may control at least one of the input detection driving circuit TIC, the gate driver circuit GDC, the data driver circuit DCC, and the emission control circuit ECC. The signal control circuit SCC may receive image data and control signals from an external graphics controller (not shown in FIGS. 2A and/or 2B). The control signals may include a vertical sync signal, a horizontal sync signal, a data enable signal, and a clock signal. The vertical sync signal may be a signal distinguishing frame intervals. The horizontal sync signal may be a signal distinguishing horizontal sections (i.e., row distinction signals).

Although it is illustrated in FIG. 2A that the gate driver circuit GDC and the emission control circuit ECC are separate components spaced apart from each other, the gate driver circuit GDC and the emission control circuit ECC of the disclosure are not limited to this configuration. In another embodiment, the gate driver circuit GDC and the emission control circuit ECC may be provided as a single component. In other embodiments, the display panel DP may be bent about a bending area.

FIG. 3A illustrates a schematic diagram of an equivalent circuit of a pixel PX according to an embodiment of the disclosure. Referring to FIG. 3A, the display panel DP of FIGS. 2A and 2B may include a data line DL, a power line PL, a first gate line GL1, a second gate line GL2, a third gate line GL3, a fourth gate line GLA, a first initialization line INL1, a second initialization line INL2, an emission control line ECL, a bias signal line BL in the pixel PX. The pixel PX may be provided in plurality.

The data line DL may provide a data signal DS to the pixel PX. In an embodiment, the voltage value of the data signal DS may be in a range of about 0.5 V to about 6.8 V. However, the voltage value of the data signal DS of the disclosure is not limited to this range and may vary as needed.

The power line PL may provide a first power signal ELVDD to the pixel PX. The voltage value of the first power signal ELVDD may be in a range of about 4.1 V to about 5.1 V. For example, the voltage value of the first power signal ELVDD may be about 4.6 V. However, the voltage value of the first power signal ELVDD of the disclosure is not limited to what is described herein and may be modified as needed.

The first gate line GL1 may provide a first gate signal GW to the pixel PX. The second gate line GL2 may provide a second gate signal GC to the pixel PX. The third gate line GL3 may provide a third gate signal GI to the pixel PX. The voltage value of the third gate signal GI may be in a range of about −8.0 V to about 6.5 V. However, the voltage value of the third gate signal GI of the disclosure is not limited to this range and may be modified as needed. The fourth gate line GL4 may provide a fourth gate signal GB to the pixel PX.

The first initialization line INL1 may provide a first initialization signal VINT to the pixel PX. The voltage value of the first initialization signal VINT may be in a range of about −3.0 V to about −2.0 V. For example, the voltage value of the first initialization signal VINT may be about −2.5 V. However, the voltage value of the first initialization signal VINT of the disclosure is not limited to what is described herein and may be modified as needed.

The second initialization line INL2 may provide a second initialization signal AINT to the pixel PX. In an embodiment, the voltage value of the second initialization signal AINT may be in a range of about −1.9 V to about −0.5 V. For example, the voltage value of the second initialization signal AINT may be about −1.4 V. However, the voltage value of the second initialization signal AINT of the disclosure is not limited to what is described herein and may be modified as needed.

The emission control line ECL may provide an emission control signal EM to the pixel PX. The bias signal line BL may provide a bias signal BS to the pixel PX. The voltage value of the bias signal BS may be in a range of about 5.0 V to about 6.0 V. For example, the voltage value of the bias signal BS may be about 5.5 V. However, the voltage value of the bias signal BS of the disclosure is not limited to what is described herein and may be modified as needed.

In an embodiment, the display panel DP may be an emission-type display panel. For example, the display panel DP may be any of an organic light-emitting display panel, a quantum dot light-emitting display panel, a micro-LED display panel, a liquid crystal display panel, an electrophoretic display panel, or an electrowetting display panel. A light-emitting layer of the organic light-emitting display panel may include an organic light-emitting material. The display panel DP may also be any of an inorganic light-emitting display panel. The inorganic light-emitting display panel may include inorganic-material-based quantum dot light-emitting display panels and micro light-emitting display panels. Hereinafter, the display panel DP will be described based on an organic light-emitting display panel.

In an embodiment, at least any one of the second gate line GL2, the third gate line GL3, the fourth gate line GL4, the first initialization line INL1, the second initialization line INL2, the emission control line ECL, and the bias signal line BL may be omitted.

The pixel PX may include a pixel circuit PC and a light-emitting diode LD. The structure of the pixel PX is not limited to the structure shown in FIG. 3A. In another embodiment, the pixel PX may be implemented in various forms to emit light from the light-emitting diode LD.

The pixel circuit PC may control the current flowing through the light-emitting diode LD in response to the data signal DS. The pixel circuit PC may include a driving transistor T1, a switching transistor T2, a compensation transistor T3, a first initialization transistor T4, a first emission transistor T5, a second emission transistor T6, a second initialization transistor T7, a bias transistor T8, a first capacitor CST, and a second capacitor CSH.

In an embodiment, at least one of the first initialization transistor T4, the first emission transistor T5, the second emission transistor T6, the second initialization transistor T7, and the bias transistor T8 may be omitted.

In an embodiment, the pixel PX may be a hybrid oxide polysilicon (HOP) pixel suitable for low-frequency driving. For example, the compensation transistor T3 and the first initialization transistor T4 may each be an oxide thin-film transistor. On the other hand, the driving transistor T1, the switching transistor T2, the first emission transistor T5, the second emission transistor T6, the second initialization transistor T7, and the bias transistor T8 may each be a low-temperature polycrystalline silicon (LTPS) thin-film transistor. However, the pixel PX of the disclosure is not limited to what is described herein, and the pixel PX may be configured with various combinations of oxide thin-film transistors and LTPS thin-film transistors.

In In an embodiment, the driving transistor T1, the switching transistor T2, the first emission transistor T5, the second emission transistor T6, the second initialization transistor T7, and the bias transistor T8 may each be one of an NMOS transistor or a PMOS transistor. Conversely, the compensation transistor T3 and the first initialization transistor T4 may be the other of the NMOS transistor or the PMOS transistor. However, the pixel PX of the disclosure is not limited to what is described herein and may be configured with various combinations of NMOS and PMOS transistors.

The driving transistor T1 may control the current flowing through the light-emitting diode LD in response to the voltage at the control electrode. The driving transistor T1 may be electrically connected to the light-emitting diode LD. The driving transistor T1 may include an input electrode, an output electrode, a control electrode, and a sub-control electrode. The input electrode may be one of the source electrode and the drain electrode, and the output electrode may be the other of the source electrode and the drain electrode. The control electrode may be a gate electrode, and the sub-control electrode may be a back gate electrode. The sub-control electrode of the driving transistor T1 may be electrically connected to the power line PL.

The switching transistor T2 may be controlled by the first gate signal GW. The switching transistor T2 may be connected between the data line DL and the driving transistor T1. The switching transistor T2 may be turned on by the first gate signal GW to transfer at least part of the data signal DS to the input electrode of the driving transistor T1.

The compensation transistor T3 may be connected between the output electrode of the driving transistor T1 and the control electrode of the driving transistor T1. The compensation transistor T3 may be controlled by the second gate signal GC. In case that the compensation transistor T3 is turned on by the second gate signal GC, the driving transistor T1 may be accessed in the form of a diode.

The first initialization transistor T4 may be connected between the first initialization line INL1 and the control electrode of the driving transistor T1. The first initialization transistor T4 may be controlled by the third gate signal GI. The first initialization transistor T4 may be turned on by the third gate signal GI to transfer at least part of the first initialization signal VINT to the control electrode of the driving transistor T1.

The first emission transistor T5 may be controlled by the emission control signal EM. The first emission transistor T5 may be connected between the power line PL and the driving transistor T1. The first emission transistor T5 may be turned on by the emission control signal EM to transfer at least part of the first power signal ELVDD to the input electrode of the driving transistor T1.

The second emission transistor T6 may be controlled by the emission control signal EM. The second emission transistor T6 may be connected between the driving transistor T1 and the light-emitting diode LD. The second emission transistor T6 may be turned on by the emission control signal EM to electrically connect the output electrode of the driving transistor T1 to the light-emitting diode LD.

The second initialization transistor T7 may be connected between the second initialization line INL2 and the light-emitting diode LD. The second initialization transistor T7 may be controlled by the fourth gate signal GB. For example, the second initialization transistor T7 may be turned on by the fourth gate signal GB to transfer at least part of the second initialization signal AINT to the light-emitting diode LD.

The second initialization transistor T7 may be used to improve the black-level expression capability of the pixel PX. In case that the second initialization transistor T7 is turned on, a parasitic capacitor CLD of the light-emitting diode LD may discharge, reducing the leakage current generated by the driving transistor T1. As a result, in case that implementing black brightness, the emission of the light-emitting diode LD caused by the leakage current may be prevented, thereby improving the black-level expression capability.

The bias transistor T8 may be connected between the bias signal line BL and the driving transistor T1. The bias transistor T8 may be controlled by the same signal (e.g., fourth gate signal) GB as the second initialization transistor T7. For example, the bias transistor T8 may be turned on by the fourth gate signal GB to transfer at least part of the bias signal BS to the input electrode of the driving transistor T1. The bias signal BS may contribute to maintaining the turn-on state of the driving transistor T1 for a predetermined (or selected) time. For example, the bias transistor T8 may be used to implement an always-on display (AOD) mode.

The first capacitor CST may be connected between the power line PL and the compensation transistor T3. The first capacitor CST may store a charge amount corresponding to the data signal DS. The second capacitor CSH may be connected between the power line PL and the driving transistor T1. The second capacitor CSH may store a charge amount corresponding to the voltage value at the input electrode of the driving transistor T1. Based on the charge amounts stored in the first capacitor CST and the second capacitor CSH, the current flowing through the light-emitting diode LD may be adjusted in case that the first emission transistor T5 and the second emission transistor T6 are turned on.

The light-emitting diode LD may emit light with a predetermined (or selected) brightness corresponding to the current value provided by the pixel circuit PC. For this, the voltage value of the first power signal ELVDD may be set higher than the voltage value of the second power signal ELVSS. One end of the light-emitting diode LD may be electrically connected to the second emission transistor T6. The other end of the light-emitting diode LD may have the second power signal ELVSS applied thereto. The light-emitting diode LD may include the parasitic capacitor CLD. In an embodiment, the light-emitting diode LD may be an organic light-emitting diode (OLED). However, the light-emitting diode LD of the disclosure is not limited to an OLED and may be any device that emits light in response to electrical signals.

FIG. 3B is a schematic waveform diagram illustrating signals input to the pixel PX of FIG. 3A. FIG. 3C illustrates a schematic waveform diagram in which signals T1_source, T1_Drain, T1_Gate, Anode, and i_EL output from the pixel PX in response to the signals of FIG. 3B are categorized according to the capacitance of the second capacitor CSH.

Referring to FIG. 3C, a first waveform LN1 corresponds to the case where the capacitance of the second capacitor CSH is about 4.96×10⁻¹⁵ F, a second waveform LN2 corresponds to the case where the capacitance of the second capacitor CSH is about 8.96×10⁻¹⁵ F, a third waveform LN3 corresponds to the case where the capacitance of the second capacitor CSH is about 1.96×10⁻¹⁴ F, and a fourth waveform LN4 corresponds to the case where the capacitance of the second capacitor CSH is about 4.96×10⁻¹⁴ F.

Referring to FIG. 3B, in an embodiment, during a first period PR1, the compensation transistor T3 may be turned on by the second gate signal GC, and the first initialization transistor T4 may be turned on by the third gate signal GI. In other words, the first initialization transistor T4 may be turned on simultaneously with the compensation transistor T3 during the first period PR1.

In this specification, the compensation voltage refers to the voltage corresponding to the amount of charge stored in the second capacitor CSH. During a second period PR2, the compensation transistor T3 may be turned off, and the compensation voltage may be provided to the output electrode of the driving transistor T1. Therefore, the larger the capacitance of the second capacitor CSH, the greater the voltage value at the output electrode of the driving transistor T1 during the second period PR2. For example, during the second period PR2, in case that the capacitance of the second capacitor CSH is about 4.96×10⁻¹⁵ F (LN1), the voltage value T1_Drain at the output electrode of the driving transistor T1 may be the smallest. Conversely, in case that the capacitance of the second capacitor CSH is about 4.96×10⁻¹⁴ F (LN4), the voltage value T1_Drain at the output electrode of the driving transistor T1 may be the largest.

In case that the compensation transistor T3 is turned on after the second period PR2, the voltage at the output electrode of the driving transistor T1 may be provided to the control electrode of the driving transistor T1 through the compensation transistor T3. Thus, the larger the capacitance of the second capacitor CSH, the higher the voltage value at the control electrode of the driving transistor T1 may be maintained.

During the third period PR3, the first emission transistor T5 and the second emission transistor T6 may be turned on by the emission control signal EM. In an embodiment, the driving transistor T1 in the pixel PX may be a PMOS transistor. For example, the larger the voltage value at the control electrode of the driving transistor T1, the smaller the current flowing through the light-emitting diode LD. Accordingly, the brightness of the light emitted by the light-emitting diode LD decreases, thereby improving image quality in low grayscale levels on the electronic device.

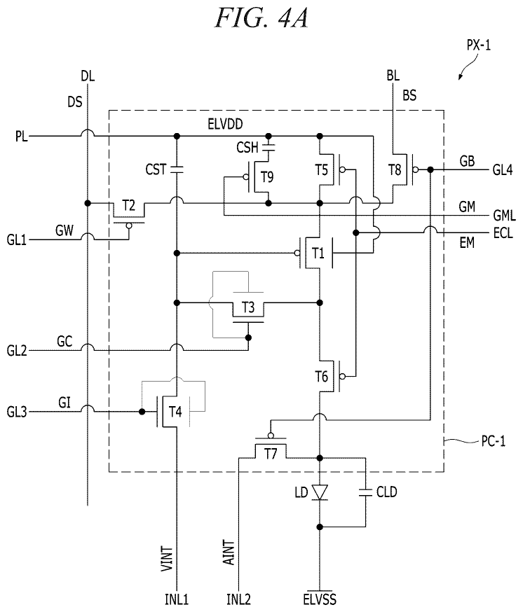

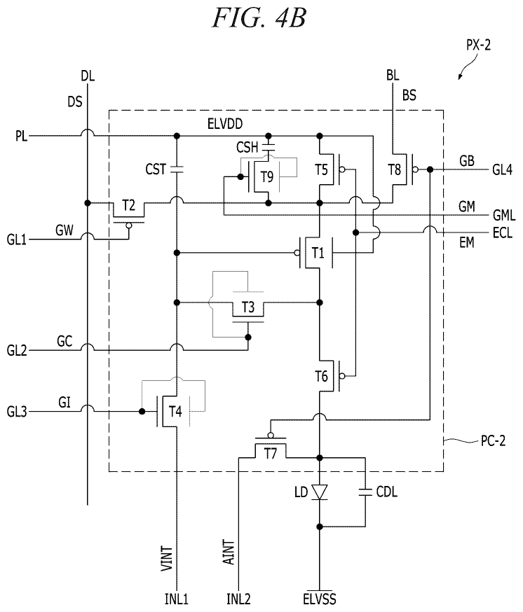

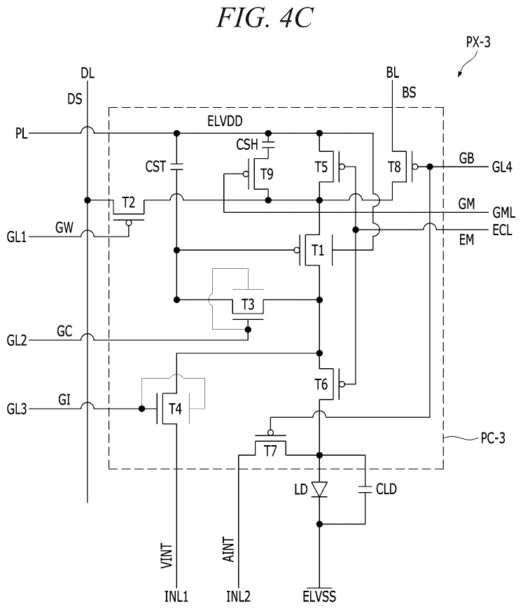

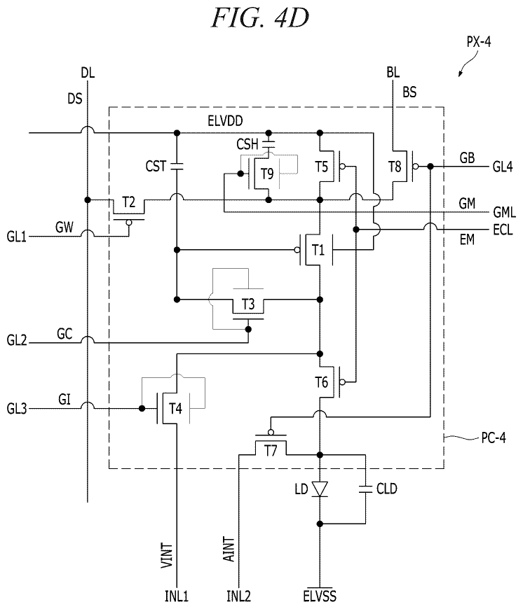

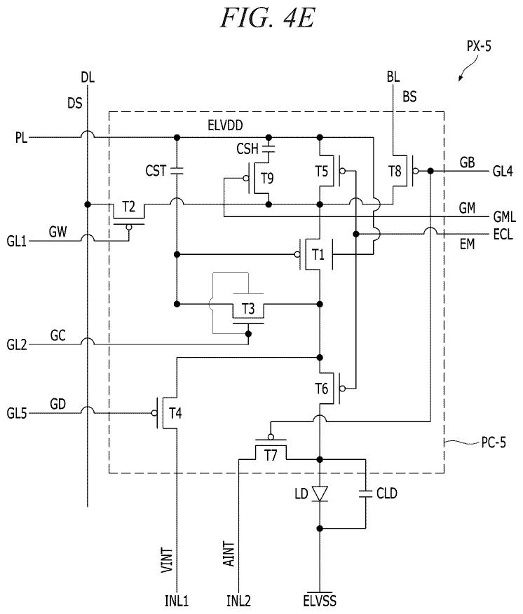

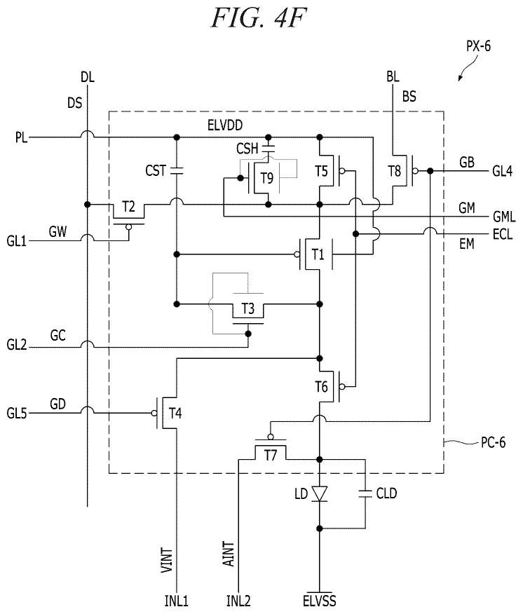

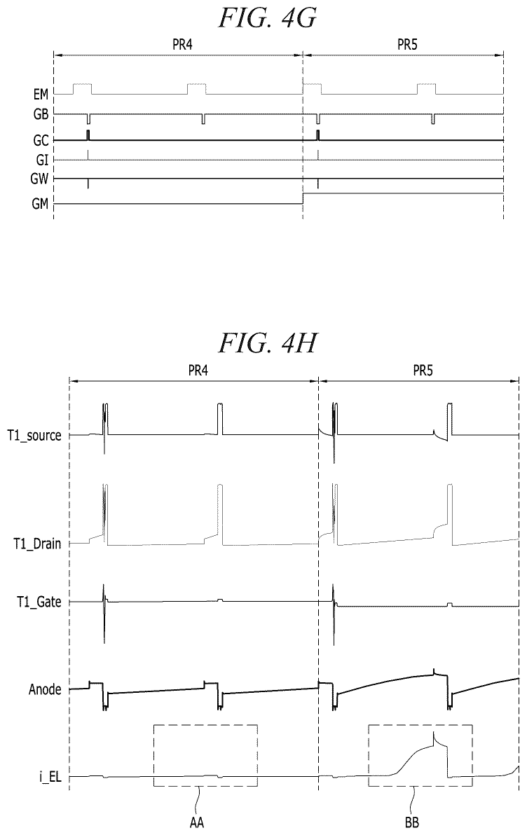

FIGS. 4A to 4F each illustrate a schematic diagram of an equivalent circuit of a pixel further including a sub-compensation transistor T9. FIGS. 4G and 4H are schematic waveform diagrams illustrating input signals and output signals of the pixel PX-1 in FIG. 4A, respectively.

Referring to FIGS. 4A to 4F, each of the pixels PX-1, PX-2, PX-3, PX-4, PX-5, and PX-6 may further include a compensation signal line GML and a sub-compensation transistor T9, compared to the pixel PX shown in FIG. 3. The compensation signal line GML may be configured to provide a compensation control signal GM. The sub-compensation transistor T9 may be connected between the power line PL and the second capacitor CSH. The sub-compensation transistor T9 may be turned on by the compensation control signal GM to electrically connect the second capacitor CSH to the input electrode of the driving transistor T1. For example, in case that the sub-compensation transistor T9 is turned on, the compensation voltage of the second capacitor CSH may be provided to the input electrode of the driving transistor T1. In another embodiment, the sub-compensation transistor T9 may be connected between the second capacitor CSH and the driving transistor T1.

In an embodiment, the sub-compensation transistor T9 may be turned on in case that the data signal DS corresponds to a low grayscale. On the other hand, the sub-compensation transistor T9 may be turned off in case that the data signal DS corresponds to a high grayscale.

In an embodiment, the sub-compensation transistor T9 may be an oxide thin-film transistor. In another embodiment, the sub-compensation transistor T9 may be a low-temperature polycrystalline silicon (LTPS) thin-film transistor. In an embodiment, the sub-compensation transistor T9 may be a PMOS transistor. In another embodiment, the sub-compensation transistor T9 may be an NMOS transistor.

Referring to FIGS. 4A, 4C, and 4E, in an embodiment, the sub-compensation transistor T9 may be a PMOS transistor. Referring to FIGS. 4B, 4D, and 4F, in an embodiment, the sub-compensation transistor T9 may be an NMOS transistor.

Referring to FIGS. 4C to 4F, in an embodiment, the first initialization transistor T4 may be connected between the first initialization line INL1 and the output electrode of the driving transistor T1.

Referring to FIGS. 4E and 4F, in an embodiment, each of the pixels PX-5 and PX-6 may further include a fifth gate line GL5. The fifth gate line GL5 may provide a fifth gate signal GD. In each of the pixels PX-5 and PX-6, the third gate line GL3 may be omitted.

In an embodiment, the bias transistor T8 may be controlled by the fourth gate signal GB, and the first initialization transistor T4 may be controlled by the fifth gate signal GD. The fifth gate signal GD and the fourth gate signal GB may have a same waveform and different phases. In an embodiment, the fifth gate signal GD may be delayed by a predetermined (or selected) interval compared to the fourth gate signal GB. Accordingly, the bias transistor T8 and the first initialization transistor T4 may be turned on sequentially.

FIG. 4G is a schematic waveform diagram illustrating the signals input to the pixel PX-1 in FIG. 4A. FIG. 4H is a schematic waveform diagram illustrating the signals T1_source, T1_Drain, T1_Gate, Anode, and i_EL output from the pixel PX-1 in response to the signals in FIG. 4A.

Referring to FIG. 4G, the sub-compensation transistor T9 may be configured to be turned on by the compensation control signal GM during a fourth period PR4 and turned off during a fifth period PR5. The fourth period PR4 may be a period during which the electronic device DD displays an image corresponding to a low grayscale, and the fifth period PR5 may be a period during which the electronic device DD displays an image corresponding to a high grayscale. In other words, the sub-compensation transistor T9 may be turned on in case that the electronic device DD displays an image corresponding to a low grayscale, and the sub-compensation transistor T9 may be turned off in case that the electronic device DD displays an image corresponding to a high grayscale.

In case that the compensation transistor T3 and the sub-compensation transistor T9 are simultaneously turned on during the fourth period PR4, the compensation voltage of the second capacitor CSH may be provided to the control electrode of the driving transistor T1 through the compensation transistor T3. Referring to a first area AA, in case that the sub-compensation transistor T9 is turned on, the current i_EL flowing through the light-emitting diode LD may be suppressed. Therefore, the image quality of the electronic device DD in low grayscale may be improved.

On the other hand, since the sub-compensation transistor T9 is turned off during the fifth period PR5, the compensation voltage of the second capacitor CSH may not be provided to the control electrode of the driving transistor T1. Referring to the first area AA and a second area BB, the current i_EL flowing through the light-emitting diode LD may not be suppressed in case that the sub-compensation transistor T9 is turned off. Therefore, the image quality of the electronic device DD in low grayscale may not be improved.

The remaining description of the components of FIGS. 4A to 4F is substantially identical to that described with reference to FIG. 3A and is thus omitted.

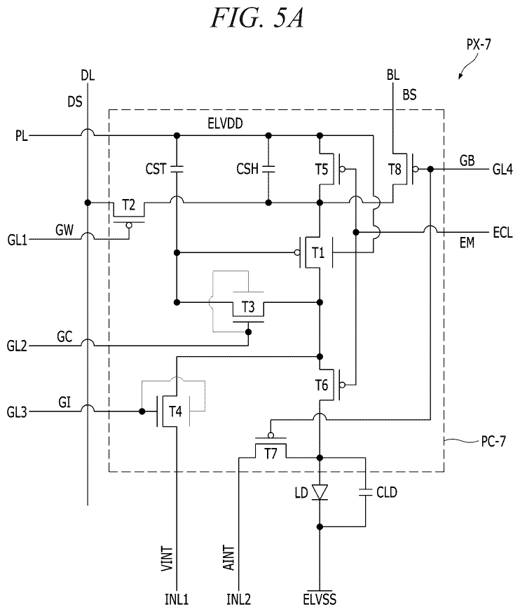

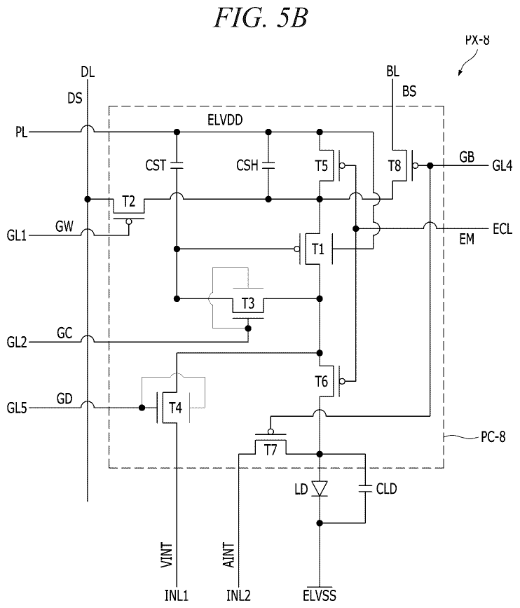

FIGS. 5A and 5B each illustrate a schematic diagram of an equivalent circuit of a pixel PX-7 or PX-8 in which the driving transistor T1 and the first initialization transistor T4 are connected in a manner different from that shown in FIG. 3.

Referring to FIGS. 5A and 5B, in an embodiment, the first initialization transistor T4 may be connected between the first initialization line INL1 and the output electrode of the driving transistor T1. The first initialization transistor T4 may be turned on simultaneously with the compensation transistor T3 during a predetermined (or selected) period PR1 of FIGS. 3A and 3B.

Referring to FIG. 5B, in an embodiment, the pixel PX-8 may further include a fifth gate line GL5. The fifth gate line GL5 may provide a fifth gate signal GD. As in the pixels PX-5 according to an embodiment of the disclosure, the third gate line GL3 may be omitted.

In an embodiment, the bias transistor T8 may be controlled by the fourth gate signal GB, and the first initialization transistor T4 may be controlled by the fifth gate signal GD. The fifth gate signal GD and the fourth gate signal GB may have a same waveform and different phases. In an embodiment, the fifth gate signal GD may be delayed by a predetermined (or selected) interval compared to the fourth gate signal GB. Accordingly, the bias transistor T8 and the first initialization transistor T4 may be turned on sequentially.

The remaining description of the components of FIGS. 5A and 5B is substantially identical to that described with reference to FIG. 3A and is thus omitted.

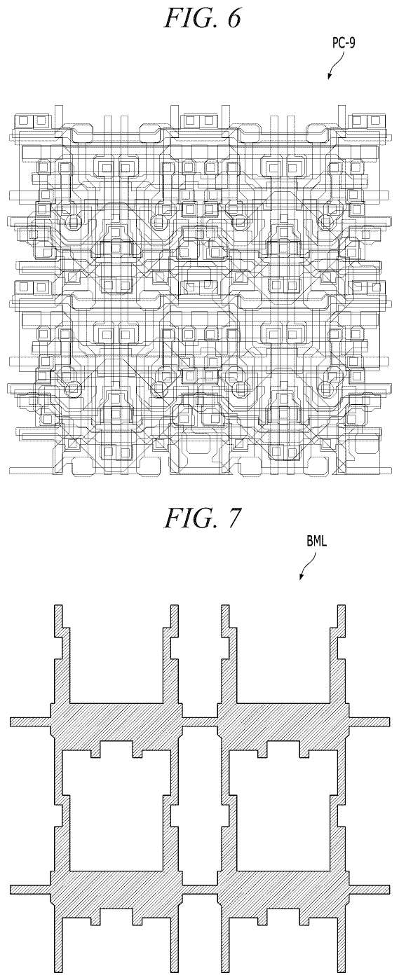

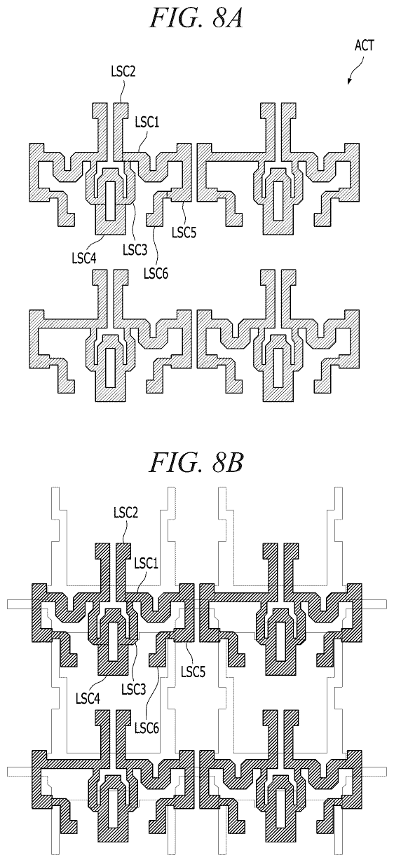

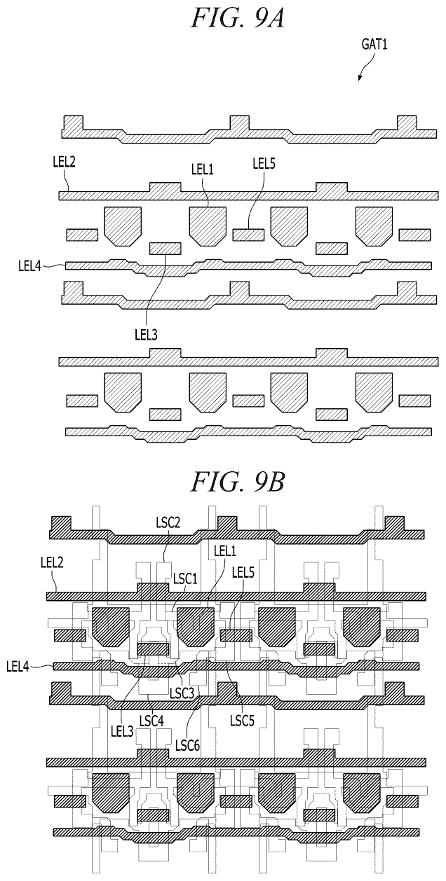

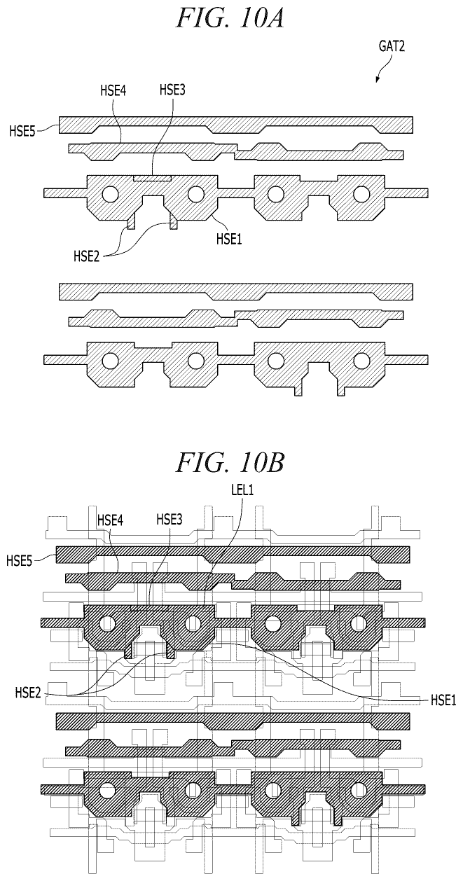

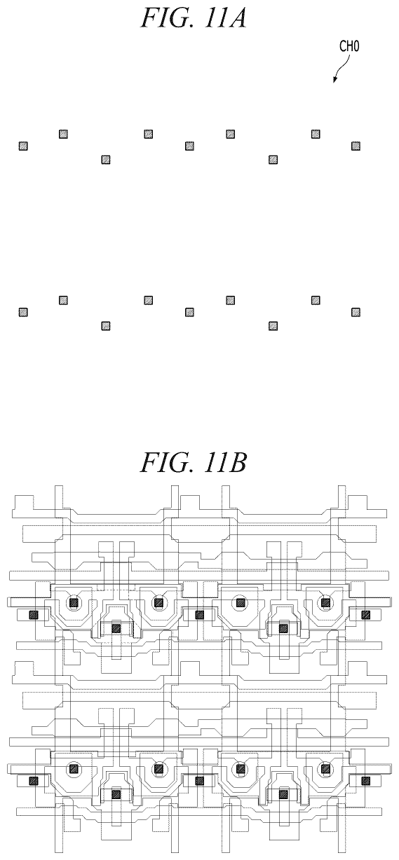

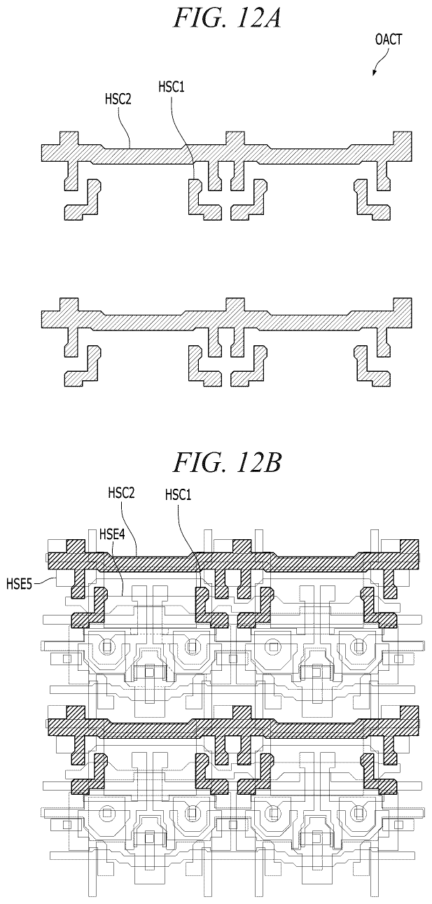

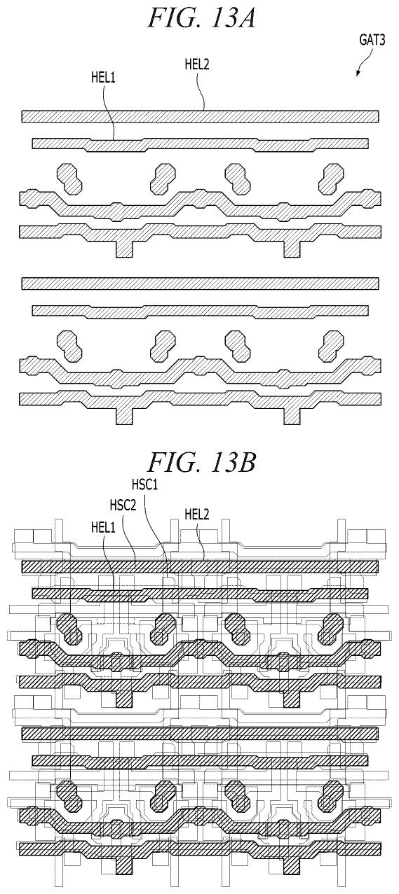

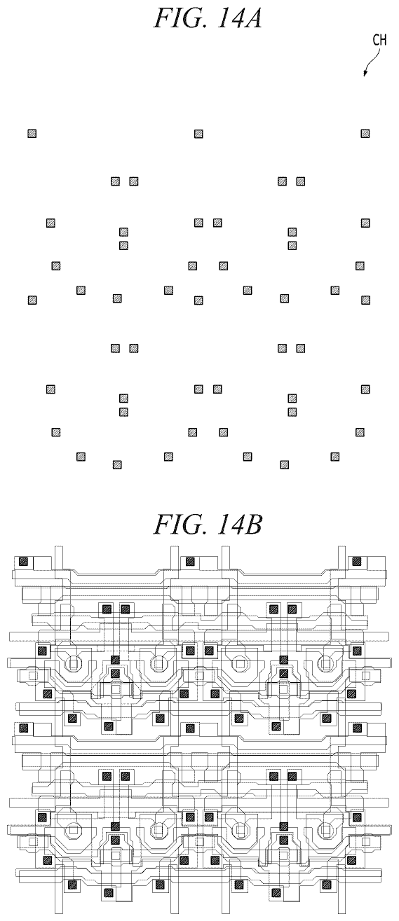

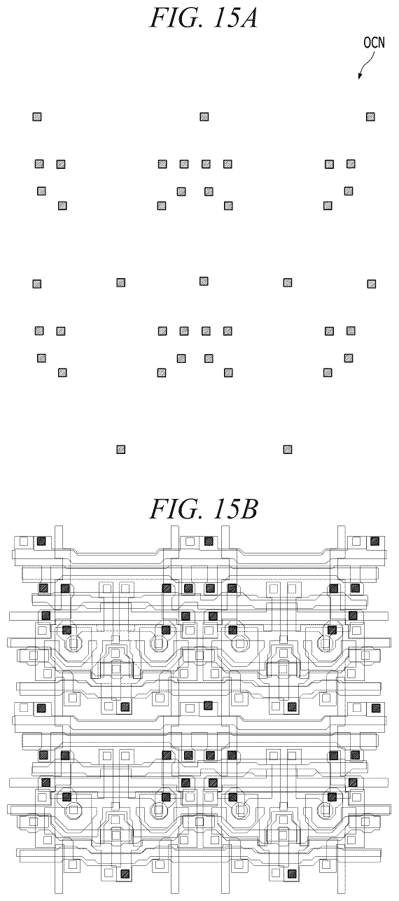

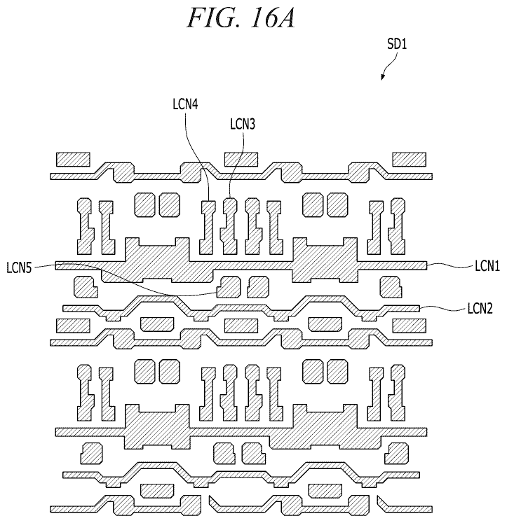

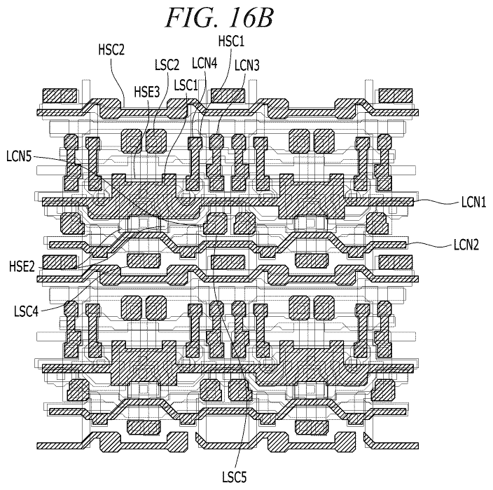

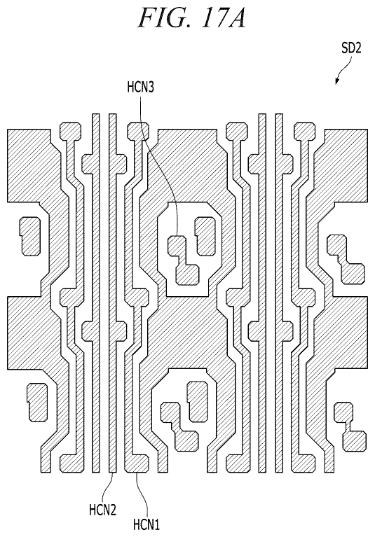

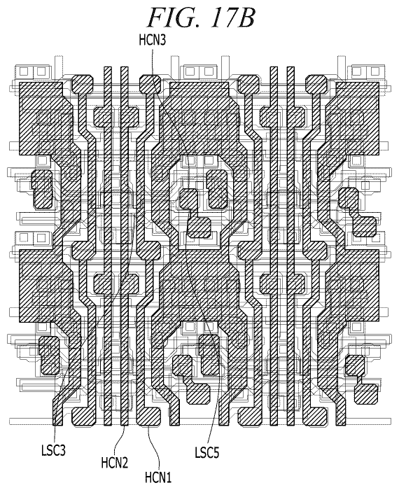

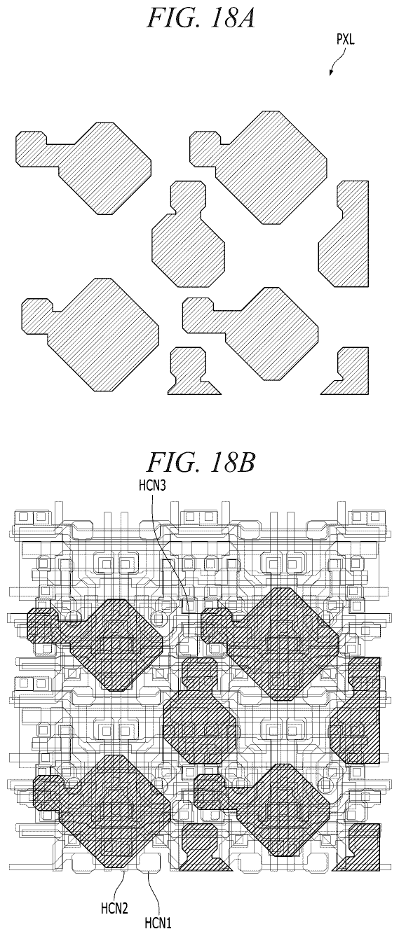

FIG. 6 is a schematic plan view illustrating the layout of a pixel circuit PC-9 according to an embodiment of the disclosure. The layout of the pixel circuit PC-9 may have patterns overlapped therein. The display panel according to an embodiment of the disclosure may include a metal pattern BML, a first semiconductor pattern ACT of FIG. 8A, a first conductive pattern GAT1 of FIG. 9A, a second conductive pattern GAT2 of FIG. 10A, a first contact pattern CH0 of FIG. 11A, a second semiconductor pattern OACT of FIG. 12A, a third conductive pattern GAT3 of FIG. 13A, a second contact pattern CH of FIG. 14A, a third contact pattern OCN of FIG. 15A, a lower-connection electrode pattern SD1 of FIG. 16A, an upper-connection electrode pattern SD2 of FIG. 17A, and an anode pattern PXL of FIG. 18A.

FIG. 7 is a schematic plan view of the metal pattern BML. The metal pattern BML may provide the first power signal ELVDD.

FIG. 8A is a schematic plan view of the first semiconductor pattern ACT. Referring to FIG. 8A, the first semiconductor pattern ACT may include a first lower-semiconductor portion LSC1, a second lower-semiconductor portion LSC2, a third lower-semiconductor portion LSC3, a fourth lower-semiconductor portion LSC4, a fifth lower-semiconductor portion LSC5, and a sixth lower-semiconductor portion LSC6.

The first lower-semiconductor portion LSC1, the second lower-semiconductor portion LSC2, the third lower-semiconductor portion LSC3, the fourth lower-semiconductor portion LSC4, and the sixth lower-semiconductor portion LSC6 may be elements constituting, respectively, the driving transistor T1, the switching transistor T2, the first emission transistor T5, the bias transistor T8, and the second initialization transistor T7.

The second lower-semiconductor portion LSC2 and the third lower-semiconductor portion LSC3 may each extend from one end of the first lower-semiconductor portion LSC1. The fourth lower-semiconductor portion LSC4 may extend from the third lower-semiconductor portion LSC3. The fifth lower-semiconductor portion LSC5 may extend from the other end of the first lower-semiconductor portion LSC1. The sixth lower-semiconductor portion LSC6 may extend from the fifth lower-semiconductor portion LSC5.

In an embodiment, each of the first to sixth lower-semiconductor portions LSC1 to LSC6 may include a silicon semiconductor. The silicon semiconductor may include at least one of amorphous silicon and polycrystalline silicon. For example, each of the first to sixth lower-semiconductor portions LSC1 to LSC6 may include, but not limited to, low-temperature polycrystalline silicon (LTPS).

FIG. 8B is an illustration of a layout in which FIG. 8A overlaps FIG. 7. Referring to FIG. 8B, the first semiconductor pattern ACT may be disposed on the metal pattern BML. The first lower-semiconductor portion LSC1 may overlap the metal pattern BML. The portion of the metal pattern BML that overlaps with the first lower-semiconductor portion LSC1 may constitute the sub-control electrode of the driving transistor T1. Although, in FIG. 8B, the portion of FIG. 8A is depicted darker than the portion of FIG. 7 for the sake of illustration, the shape and color of the first semiconductor pattern ACT in the disclosure are not limited to this representation.

FIG. 9A is a plan view of the first conductive pattern GAT1. Referring to FIG. 9A, the first conductive pattern GAT1 may include first to fifth lower-electrode portions LEL1 to LEL5. The first to fifth lower-electrode portions LEL1 to LEL5 may be arranged to be spaced apart from one another.

FIG. 9B is an illustration of a layout in which FIG. 9A overlaps FIG. 8B. Referring to FIG. 9B, the first conductive pattern GAT1 may be disposed on the first semiconductor pattern ACT. The first to fifth lower-electrode portions LEL1 to LEL5 may overlap the first to fifth lower-semiconductor portions LSC1 to LSC5, respectively. Although, in FIG. 9B, the portion of FIG. 9A is depicted darker than the portion of FIG. 8B for the sake of illustration, the shape and color of the first conductive pattern GAT1 in the disclosure are not limited to this representation.

The first lower-electrode portion LEL1 may overlap the first lower-semiconductor portion LSC1. The portion of the first lower-electrode portion LEL1 overlapping the first lower-semiconductor portion LSC1 may constitute the control electrode of the driving transistor T1.

The second lower-electrode portion LEL2 may overlap the second lower-semiconductor portion LSC2. The portion of the second lower-electrode portion LEL2 overlapping the second lower-semiconductor portion LSC2 may constitute the control electrode of the switching transistor T2.

The third lower-electrode portion LEL3 may overlap the third lower-semiconductor portion LSC3. The portion of the third lower-electrode portion LEL3 overlapping the third lower-semiconductor portion LSC3 may constitute the control electrode of the first emission transistor T5.

The fourth lower-electrode portion LELA may overlap both the fourth lower-semiconductor portion LSC4 and the sixth lower-semiconductor portion LSC6. The portion of the fourth lower-electrode portion LELA overlapping the fourth lower-semiconductor portion LSC4 may constitute the control electrode of the bias transistor T8. The portion of the fourth lower-electrode portion LEL4 overlapping the sixth lower-semiconductor portion LSC6 may constitute the control electrode of the second initialization transistor T7.

The fifth lower-electrode portion LEL5 may overlap the fifth lower-semiconductor portion LSC5. The portion of the fifth lower-electrode portion LEL5 overlapping the fifth lower-semiconductor portion LSC5 may constitute the control electrode of the second emission transistor T6.

FIG. 10A is a schematic plan view of the second conductive pattern GAT2. Referring to FIG. 10A, the second conductive pattern GAT2 may include a first upper-sub-electrode portion HSE1, a second upper-sub-electrode portion HSE2, a third upper-sub-electrode portion HSE3, a fourth upper-sub-electrode portion HSE4, and a fifth upper-sub-electrode portion HSE5.

The second upper-sub-electrode portion HSE2 and the third upper-sub-electrode portion HSE3 may each extend from the first upper-sub-electrode portion HSE1. The fourth upper-sub-electrode portion HSE4 may be arranged to be spaced apart from the first upper-sub-electrode portion HSE1, the second upper-sub-electrode portion HSE2, the third upper-sub-electrode portion HSE3, and the fifth upper-sub-electrode portion HSE5. The fifth upper-sub-electrode portion HSE5 may be arranged to be spaced apart from the first upper-sub-electrode portion HSE1, the second upper-sub-electrode portion HSE2, the third upper-sub-electrode portion HSE3, and the fourth upper-sub-electrode portion HSE4.

FIG. 10B is an illustration of a layout in which FIG. 10A overlaps FIG. 9B. Referring to FIG. 10B, the second conductive pattern GAT2 may be disposed on the first conductive pattern GAT1. The first to third upper-sub-electrode portions HSE1 to HSE3 may each overlap the first lower-electrode portion LEL1.

The first capacitor CST is defined in the region where the first lower-electrode portion LEL1 and the first upper-sub-electrode portion HSE1 overlap each other. One portion of the second capacitor CSH is defined in the region where the metal pattern BML and the second upper-sub-electrode portion HSE2 overlap each other. Another portion of the second capacitor CSH is defined in the region where the metal pattern BML and the third upper-sub-electrode portion HSE3 overlap each other.

Although, in FIG. 10B, the portion representing FIG. 10A is depicted darker than the portion representing FIG. 9B for the sake of illustration, the shape and color of the second conductive pattern GAT2 in the disclosure are not limited to this representation.

FIG. 11A is a schematic plan view of the first contact pattern CH0. FIG. 11B is an illustration of a layout in which FIG. 11A overlaps with FIG. 10B. Although, in FIG. 11B, the portion representing FIG. 11A is depicted darker than the portion representing FIG. 10B for the sake of illustration, the shape and color of the first contact pattern CH0 in the disclosure are not limited to this representation.

FIG. 12A is a schematic plan view of the second semiconductor pattern OACT. Referring to FIG. 12A, the second semiconductor pattern OACT may include a first upper-semiconductor portion HSC1 and a second upper-semiconductor portion HSC2. The first upper-semiconductor portion HSC1 and the second upper-semiconductor portion HSC2 may be arranged to be spaced apart from each other.

The first upper-semiconductor portion HSC1 may constitute the compensation transistor T3. The second upper-semiconductor portion HSC2 may constitute the first initialization transistor T4.

In an embodiment, the first upper-semiconductor portion HSC1 and the second upper-semiconductor portion HSC2 may each include at least one of a metal oxide, crystalline oxide semiconductor, and amorphous oxide semiconductor. For example, the oxide semiconductor may include at least one of indium-tin oxide (ITO), indium-gallium-zinc oxide (IGZO), zinc oxide (ZnO), indium-zinc oxide (IZnO), zinc-indium oxide (ZIO), indium oxide (InO), titanium oxide (TiO), indium-zinc-tin oxide (IZTO), and zinc-tin oxide (ZTO).

FIG. 12B is an illustration of a layout in which FIG. 12A overlaps with FIG. 11B. Referring to FIG. 12B, the second semiconductor pattern OACT may be disposed on the second conductive pattern GAT2.

The first upper-semiconductor portion HSC1 may overlap the fourth upper-sub-electrode portion HSE4. The portion of the fourth upper-sub-electrode portion HSE4 that overlaps the first upper-semiconductor portion HSC1 may constitute the sub-control electrode of the compensation transistor T3.

The second upper-semiconductor portion HSC2 may overlap the fifth upper-sub-electrode portion HSE5. The portion of the fifth upper-sub-electrode portion HSE5 that overlaps the second upper-semiconductor portion HSC2 may constitute the sub-control electrode of the first initialization transistor T4.

Although, in FIG. 12B, the portion representing FIG. 12A is depicted darker than the portion representing FIG. 11B for the sake of illustration, the shape and color of the second semiconductor pattern OACT in the disclosure are not limited to this representation.

FIG. 13A is a schematic plan view of the third conductive pattern GAT3. Referring to FIG. 13A, the third conductive pattern GAT3 may include a first upper-electrode portion HEL1 and a second upper-electrode portion HEL2. The first upper-electrode portion HEL1 and the second upper-electrode portion HEL2 may be arranged to be spaced apart from each other.

FIG. 13B is an illustration of a layout in which FIG. 13A overlaps FIG. 12B. Referring to FIG. 13B, the third conductive pattern GAT3 may be disposed on the second semiconductor pattern OACT.

The first upper-electrode portion HEL1 may overlap the first upper-semiconductor portion HSC1. The portion of the first upper-electrode portion HEL1 that overlaps the first upper-semiconductor portion HSC1 may constitute the control electrode of the compensation transistor T3.

The second upper-electrode portion HEL2 may overlap the second upper-semiconductor portion HSC2. The portion of the second upper-electrode portion HEL2 that overlaps the second upper-semiconductor portion HSC2 may constitute the control electrode of the first initialization transistor T4.

Although, in FIG. 13B, the portion representing FIG. 13A is depicted darker than the portion representing FIG. 12B for the sake of illustration, the shape and color of the third conductive pattern GAT3 in the disclosure are not limited to this representation.

FIG. 14A is a schematic plan view of the second contact pattern CH. FIG. 14B is an illustration of a layout in which FIG. 14A overlaps FIG. 13B. Although, in FIG. 14B, the portion representing FIG. 14A is depicted darker than the portion representing FIG. 13B for the sake of illustration, the shape and color of the second contact pattern CH in the disclosure are not limited to this representation.

FIG. 15A is a schematic plan view of the third contact pattern OCN. FIG. 15B is an illustration of a layout in which FIG. 15A overlaps FIG. 14B. Although, in FIG. 15B, the portion representing FIG. 15A is depicted darker than the portion representing FIG. 14B for the sake of illustration, the shape and color of the third contact pattern OCN in the disclosure are not limited to this representation.

FIG. 16A is a schematic plan view of the lower-connection electrode pattern SD1. Referring to FIG. 16A, the lower-connection electrode pattern SD1 may include a first lower-connection electrode LCN1, a second lower-connection electrode LCN2, a third lower-connection electrode LCN3, a fourth lower-connection electrode LCN4, and a fifth lower-connection electrode LCN5. Each of the first to fifth lower-connection electrodes LCN1 to LCN5 may be in contact with at least one of the other patterns disposed underneath via the first to third contact patterns CH0, CH, and OCN. Specific examples of these connections are further described in detail, but the connection relationship between the lower-connection electrode pattern SD1 and other patterns is not limited to what is described herein.

FIG. 16B is an illustration of a layout in which FIG. 16A overlaps FIG. 15B. Referring to FIG. 16B, the lower-connection electrode pattern SD1 may be disposed on the third conductive pattern GAT3.

The first lower-connection electrode LCN1 may contact the first lower-semiconductor portion LSC1, the second lower-semiconductor portion LSC2, the second upper-sub-electrode portion HSE2, and the third upper-sub-electrode portion HSE3.

The second lower-connection electrode LCN2 may contact the fourth lower-semiconductor portion LSC4 and the fifth lower-semiconductor portion LSC5. The third lower-connection electrode LCN3 may contact the first upper-semiconductor portion HSC1 and the second upper-semiconductor portion HSC2. The fourth lower-connection electrode LCN4 may contact the first upper-semiconductor portion HSC1 and the first lower-semiconductor portion LSC1. The fifth lower-connection electrode LCN5 may contact the fifth lower-semiconductor portion LSC5.

Although, in FIG. 16B, the portion representing FIG. 16A is depicted darker than the portion representing FIG. 15B for the sake of illustration, the shape and color of the lower-connection electrode pattern SD1 in the disclosure are not limited to this representation.

FIG. 17A is a schematic plan view of the upper-connection electrode pattern SD2. Referring to FIG. 17A, the upper-connection electrode pattern SD2 may include a first upper-connection electrode HCN1, a second upper-connection electrode HCN2, and a third upper-connection electrode HCN3.

FIG. 17B is an illustration of a layout in which FIG. 17A overlaps FIG. 16B. Referring to FIG. 17B, the upper-connection electrode pattern SD2 may be disposed on the lower-connection electrode pattern SD1.

The first upper-connection electrode HCN1 may contact the third lower-semiconductor portion LSC3 and the fifth lower-semiconductor portion LSC5. For example, the first upper-connection electrode HCN1 may electrically connect the output electrode of the first emission transistor T5 to the input electrode of the second emission transistor T6.

Although, in FIG. 17B, the portion representing FIG. 17A is depicted darker than the portion representing FIG. 16B for the sake of illustration, the shape and color of the upper-connection electrode pattern SD2 in the disclosure are not limited to this representation.

FIG. 18A is a schematic plan view of the anode pattern PXL. FIG. 18B is an illustration of a layout in which FIG. 18A overlaps FIG. 17B.

Referring to FIG. 18B, the anode pattern PXL may be disposed on the upper-connection electrode pattern SD2. The anode pattern PXL may contact the first upper-connection electrode HCN1. For example, the anode pattern PXL may electrically connect the output electrode of the second emission transistor T6 to the light-emitting diode LD.

Although, in FIG. 18B, the portion representing FIG. 18A is depicted darker than the portion representing FIG. 17B for the sake of illustration, the shape and color of the anode pattern PXL in the disclosure are not limited to this representation.

While certain embodiments of the disclosure have been described above, anyone ordinarily skilled in the art to which the disclosure pertains shall appreciate that there may be a variety of modifications and permutations of the disclosure without departing from the technical ideas and scopes of the disclosure that are defined in the appended claims. Moreover, it shall be appreciated that the disclosed embodiments are not intended to restrict the disclosure thereto and that every technical idea within the appended claims and their equivalents is interpreted to be included in the scope of the disclosure.

What is claimed is:

1. A display panel comprising:
a pixel comprising a pixel circuit and a light-emitting diode;
a data line that provides a data signal to the pixel;
a gate line that provides a gate signal to the pixel; and
a power line that provides a power signal to the pixel,
wherein the pixel circuit comprises:
a driving transistor electrically connected to the light-emitting diode and comprising an input electrode, an output electrode, and a control electrode;
a switching transistor that is controlled by the gate signal and connected between the data line and the driving transistor;
a compensation transistor connected between the output electrode of the driving transistor and the control electrode of the driving transistor;
a first capacitor connected between the power line and the compensation transistor;
a second capacitor connected between the power line and the driving transistor; and
a sub-compensation transistor connected between the power line and the second capacitor or connected between the second capacitor and the driving transistor.

2. The display panel of claim 1, wherein the sub-compensation transistor is turned on in case that the data signal corresponds to a low grayscale, and the sub-compensation transistor is turned off in case that the data signal corresponds to a high grayscale.

3. The display panel of claim 1, further comprising:
a first initialization line that provides a first initialization signal to the pixel; and
a first initialization transistor that is turned on simultaneously with the compensation transistor for a selected period to transfer the first initialization signal.

4. The display panel of claim 3, wherein the first initialization transistor is connected between the first initialization line and an input electrode of the compensation transistor.

5. The display panel of claim 3, wherein the first initialization transistor is connected between the first initialization line and the output electrode of the driving transistor.

6. The display panel of claim 3, further comprising:
a bias signal line that provides a bias signal to the pixel; and
a bias transistor connected between the bias signal line and the driving transistor.

7. The display panel of claim 6, wherein
the bias transistor is controlled by a first signal,
the first initialization transistor is controlled by a second signal, and
the first signal and the second signal have a same waveform and different phases.

8. The display panel of claim 6, further comprising:
a second initialization line that provides a second initialization signal to the pixel; and
a second initialization transistor connected between the second initialization line and the light-emitting diode and controlled by a same signal as the bias transistor.

9. The display panel of claim 1, further comprising:
an emission control line that provides an emission control signal to the pixel;
a first emission transistor that is controlled by the emission control signal and connected between the power line and the driving transistor; and
a second emission transistor that is controlled by the emission control signal and connected between the driving transistor and the light-emitting diode.

10. A display panel comprising:
a pixel comprising a pixel circuit and a light-emitting diode;
a data line that provides a data signal to the pixel;
a gate line that provides a gate signal to the pixel;
a power line that provides a power signal to the pixel; and
a first initialization line that provides a first initialization signal to the pixel,
wherein the pixel circuit comprises:
a driving transistor electrically connected to the light-emitting diode and comprising an input electrode, an output electrode, and a control electrode;
a switching transistor that is controlled by the gate signal and connected between the data line and the driving transistor;
a compensation transistor connected between the output electrode of the driving transistor and the control electrode of the driving transistor;
a first capacitor connected between the power line and the compensation transistor;
a second capacitor connected between the power line and the driving transistor; and
a first initialization transistor connected between the first initialization line and the output electrode of the driving transistor and turned on simultaneously with the compensation transistor during a selected period.

11. The display panel of claim 10, further comprising:
a bias signal line that provides a bias signal to the pixel; and
a bias transistor connected between the bias signal line and the driving transistor wherein
the bias transistor is controlled by a first signal,
the first initialization transistor is controlled by a second signal, and
the first signal and the second signal have a same waveform and different phases.

12. The display panel of claim 11, further comprising:
a second initialization line that provides a second initialization signal to the pixel; and
a second initialization transistor connected between the second initialization line and the light-emitting diode and controlled by a same signal as the bias transistor.

13. The display panel of claim 10, further comprising a sub-compensation transistor connected between the power line and the second capacitor or connected between the driving transistor and the second capacitor.

14. The display panel of claim 13, wherein the sub-compensation transistor is turned on in case that the data signal corresponds to a low grayscale, and the sub-compensation transistor is turned off in case that the data signal corresponds to a high grayscale.

15. The display panel of claim 10, further comprising:
an emission control line that provides an emission control signal to the pixel;
a first emission transistor that is controlled by the emission control signal and connected between the power line and the driving transistor; and
a second emission transistor that is controlled by the emission control signal and connected between the driving transistor and the light-emitting diode.

16. The display panel of claim 10, wherein
the driving transistor further comprises a sub-control electrode, and the sub-control electrode is electrically connected to the power line.

17. A display panel comprising:
a metal pattern;
a first semiconductor pattern disposed on the metal pattern and comprising first to sixth lower-semiconductor portions, wherein:
the first lower-semiconductor portion overlaps the metal pattern,
the second and third lower-semiconductor portions each extend from one end of the first lower-semiconductor portion,
the fourth lower-semiconductor portion extends from the third lower-semiconductor portion,
the fifth lower-semiconductor portion extends from the other end of the first lower-semiconductor portion, and
the sixth lower-semiconductor portion extends from the fifth lower-semiconductor portion;
a first conductive pattern disposed on the first semiconductor pattern and comprising first to fifth lower-electrode portions, wherein:
the first to fifth lower-electrode portions overlap the first to fifth lower-semiconductor portions, respectively, and arranged to be spaced apart from each other;
a second conductive pattern disposed on the first conductive pattern and comprising first to fifth upper-sub-electrode portions, wherein:
the second and third upper-sub-electrode portions each extend from the first upper-sub-electrode portion,
the first to third upper-sub-electrode portions each overlaps the first lower-electrode portion, and
the fourth and fifth upper-sub-electrode portions are arranged to be spaced apart from the first to third upper-sub-electrode portions;
a second semiconductor pattern disposed on the second conductive pattern and comprising a first upper-semiconductor portion and a second upper-semiconductor portion, wherein:
the first upper-semiconductor portion overlaps the fourth upper-sub-electrode portion, and
the second upper-semiconductor portion overlaps the fifth upper-sub-electrode portion; and
a third conductive pattern disposed on the second semiconductor pattern and comprising a first upper-electrode portion and a second upper-electrode portion, wherein:
the first upper-electrode portion overlaps the first upper-semiconductor portion, and
the second upper-electrode portion overlaps the second upper-semiconductor portion.

18. The display panel of claim 17, further comprising a lower-connection electrode pattern disposed on the third conductive pattern and comprising first to fifth lower-connection electrodes, wherein
the first lower-connection electrode is in contact with the first lower-semiconductor portion, the second lower-semiconductor portion, the second upper-sub-electrode portion, and the third upper-sub-electrode portion,
the second lower-connection electrode is in contact with the fourth lower-semiconductor portion and the fifth lower-semiconductor portion,
the third lower-connection electrode is in contact with the first upper-semiconductor portion and the second upper-semiconductor portion,
the fourth lower-connection electrode is in contact with the first upper-semiconductor portion and the first lower-semiconductor portion, and
the fifth lower-connection electrode is in contact with the fifth lower-semiconductor portion.

19. The display panel of claim 18, further comprising an upper-connection electrode pattern and an anode pattern, wherein
the upper-connection electrode pattern is disposed on the lower-connection electrode pattern and comprises first to third upper-connection electrodes,
the first upper-connection electrode is in contact with the third lower-semiconductor portion and the fifth lower-semiconductor portion, and
the anode pattern is disposed on the upper-connection electrode pattern and is in contact with the first upper-connection electrode.

20. An electronic device comprising a display panel, wherein the display panel comprises:
a pixel comprising a pixel circuit and a light-emitting diode;
a data line that provides a data signal to the pixel;
a gate line that provides a gate signal to the pixel; and
a power line that provides a power signal to the pixel,
wherein the pixel circuit comprises:
a driving transistor electrically connected to the light-emitting diode and comprising an input electrode, an output electrode, and a control electrode;
a switching transistor that is controlled by the gate signal and connected between the data line and the driving transistor;
a compensation transistor connected between the output electrode of the driving transistor and the control electrode of the driving transistor;
a first capacitor connected between the power line and the compensation transistor:
a second capacitor connected between the power line and the driving transistor; and
a sub-compensation transistor connected between the power line and the second capacitor or connected between the second capacitor and the driving transistor.
